(19) United States
(12) Patent Application Publication
(10) Pub. No.: US 2008/0267196 A1
(43) Pub. Date: Oct. 30, 2008

(54) Adaptive Bandwidth Management System For Capacitor Tunnels Of A Time-Variable Communication Matrix

(75) Inventors: Michael Menth, Oellingen (DE); Jens Milbrandt, Dornhalde (DE)

Correspondence Address: BELL, BOYD & LLOYD, LLP, P.O. BOX 1135, CHICAGO, IL, 60690, US

(73) Assignee: Nokia Siemens Networks GmbH & Co. KG, Munich (DE)

(21) Appl. No.: 11/791,302

(22) PCT Filed: Nov. 11, 2005
(86) PCT No.: PCT/EP2005/055915

§ 371 Date: Apr. 30, 2008

(30) Foreign Application Priority Data
Nov. 22, 2004 (DE) 10 2004 056 306.3

(51) Int. Cl. H04L 12/66

(52) U.S. Cl. 370/401

(57) ABSTRACT

In one aspect, a communications network, wherein capacitor tunnels for particular services, for example for a quality of service are arranged on the link paths between the network nodes is provided. For preventing the capacity blocking or underused, the tunnel capacities are adapted according to a time-variable communication matrix. In a particular embodiment, a stock of transmission capacity common for a number of link paths is maintained, wherein a capacitor tunnel takes the data transmission capacity from the stock, when a top traffic threshold is exceeded or returns the data transmission capacity in the stock when the lower traffic threshold is under permissible level, respectively.

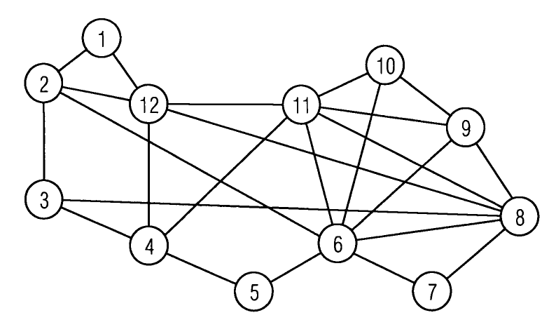

### CROSS REFERENCE TO RELATED APPLICATIONS

This application is the US National Stage of International Application No. PCT/EP2005/055915, filed Nov. 11, 2005 and claims the benefit thereof. The International Application claims the benefits of German application No. 102004056306.3 DE filed Nov. 22, 2004, both of the applications are incorporated by reference herein in their entirety.

### FIELD OF INVENTION

The subject matter of the application relates to an adaptive bandwidth management system for capacitor tunnels to prevent blocking and underutilization for time-variable communication matrices.

The subject matter of the application relates to a method for adjusting capacitor tunnels in a network having a plurality of nodes.

### BACKGROUND OF INVENTION

In communication systems there are static capacitor tunnels which divide up the bandwidth of a network in a virtual manner. These can for example be border-to-border budgets (BBBs) in the case of BBB-based network admission control (NAC) or else fixed-capacity tunnels in a (G)MPLS environment. The dimensioning of the capacitor tunnels currently has the following features:

The capacity is allocated statically to incoming traffic

If the incoming traffic for a tunnel changes temporally, the maximum value for the dimensioning must be accepted.

In accordance with these features the current method for dimensioning the capacitor tunnels may also be called static bandwidth allocation (SBA).

### SUMMARY OF INVENTION

The problem of variable incoming traffic has to date been solved using SBA, which equates to overprovisioning (excess provision of capacity) if the busy hours for traffic in the various tunnels are staggered. In the literature, reference is frequently made to the so-called multi-hour design (MHD) for solving the SBA problem. However, with MHD for networks, the network is completely redesigned at fixed intervals, which among other things results in a change in routing and load balancing. This therefore entails a massive intervention in the network.

The subject matter of the application is based on the problem of specifying a method for bandwidth management in a communication network in which neither routing nor load balancing need be changed in the network.

The problem is solved by the features of the independent claims.

In the case of the subject matter of the application—unlike with general MHD—the requisite actions are advantageously restricted to changing the tunnel capacities, without it being necessary to alter the configuration in the network.

Compared to MHD nothing alters in the configuration (routing, load balancing) of the nodes within the network. Advantages arise from reducing the number of reconfigurations required, which merely relate to the peripheral nodes (in the FIGURE all nodes outside 6) in the network which administer the tunnel capacities. As a result, signaling can be saved in the network and the status of the network is stabilized.

Advantageous developments of the subject matter of the application are specified in the dependent claims.

### BRIEF DESCRIPTION OF THE DRAWINGS

The subject matter of the application is explained in greater detail below on the basis of a FIGURE as an exemplary embodiment, to the extent required for understanding. The drawing shows:

FIGURE a basic representation of a telecommunication network.

### DETAILED DESCRIPTION OF INVENTION

The telecommunication network shown in the FIGURE is formed by a plurality of network nodes 1 to 12 and link paths (links) connecting them. In the course of a communication link, data transmitted for example in accordance with the internet protocol may be transmitted between network nodes, the communication link running in general via a plurality of nodes, for example 2, 12, 11, 6 and 7. Capacitor tunnels can be set up in the communication network which reserve transmission bandwidth over one or more links. The reservation of transmission bandwidth may be done for a particular service, for example for a data transmission with a real-time requirement, such as for example voice transmission with a quality of service (QoS) requirement. A capacity tunnel stores an adjustable fraction up to the entire transmission bandwidth/capacity of a link.

The telecommunication network is specified by its topology and the corresponding link bandwidths. A communication matrix is specified for this purpose. There are methods for distributing the network capacity between virtual tunnels so that the flows of all border-to-border (b2b) aggregates have approximately the same probability of blocking, cf.: Menth Michael, Gehrsitz Sebastian and Milbrandt Jens “Fair Assignment of Efficient Network Admission Control Budgets” pages 1121-1130, September 2003, Berlin, Germany. This method may be called “Budget Assignment” (BA). Such a method can also be extended to resilience, cf.: Michael Menth, Jens Milbrandt and Stefan Kopf “Capacity Assignment for NAC Budgets in Resilient Networks” pages 193-198, June 2004, Vienna, Austria. These methods are used for static communication matrices. However, if the traffic changes over time, a communication matrix must be accepted for capacity assignment which contains the time maxima for the respective b2b aggregates. However, it is better to adapt the capacity assignment to the current communication matrix, which in the following is referred to as “Adaptive Bandwidth Management” (ABM).

A method for measuring or for determining the communication matrix is used which for example can be achieved by logging the requests to the BBB NAC entities. As a result, the current communication matrix can be accepted as specified. Based on the current traffic load specified as a communication matrix for the network and measured in erlangs, on the composition of the traffic (distribution of the request quantities) and on the tunnel sizes, the respective probabilities of blocking can be calculated and need not be measured, which would also be technically problematic.

Two options for ABM (Adaptive Bandwidth Management) are identified:

1. Complete Capacity Reassignment (CCR)

The bandwidth allocation algorithm is used to recalculate and configure the capacities of all tunnels. There are essentially two options for triggering the CCR:

1.1 CCR is performed at fixed, predefined, periodic intervals, in other words independently of the network status. This is the intuitive procedure. A small update interval requires a high computing power and results in a lot of signaling and configuration work. A large update interval in contrast results in a long response time. Both extremes are undesirable:

1.2 CCR is executed by explicit triggering. Two mechanisms are suggested for this:

### Tolerance Intervals (TI)

1.2.1 For each tunnel we define a lower and an upper limit for the probability of blocking. An update is performed only if the probabilities of blocking have significantly changed, i.e. if the lower tunnel-specific limit of the current probability of blocking is undershot or the upper limit has been exceeded. The response to undershooting the lower limit is significant in that the probability of blocking for other tunnels can thereby be reduced by reassigning capacity. There are several options for determining the upper and lower barrier for the probability of blocking, in other words a tolerance interval. The parameter p is here the planned probability of blocking of the respective tunnel and c is a freely selectable parameter with which the update probability can be regulated:

1.2.1.1. Linear determination: [p(1−c), p(1+c)]

1.2.1.2. Logarithmic determination: [p*exp(−c), p*exp(c)]

1.2.2. Reduction Threshold (RT)

The trigger is activated only if the use of the BA algorithm leads to a significant reduction in the current probability of blocking in the case of at least one tunnel. Once again, a linear or a logarithmic lower limit (reduction threshold) can be used to specify the significant reduction. The parameter p is here the current probability of blocking of the respective tunnel and c is a freely selectable parameter with which the update probability can be regulated:

1.2.2.1. Linear limit: p(1−c)

1.2.2.2. Logarithmic limit: p*exp(−c). Since this is a single-sided limit, there is no real difference from the linear limit. This should only clarify the dimensions within which the limit may lie.

2. Selective Capacity Reassignment (SCR)

When using the BA algorithm a certain proportion of the link capacities is here retained in a free resource pool (FRP) and the rest is assigned to the tunnels. The resulting probabilities of blocking are used as planned values. The tunnel sizes are now changed selectively, i.e. no longer are the capacities of all tunnels readjusted, but only those whose probability of blocking has significantly changed. The BA algorithm leaves the capacities of all other tunnels the same and reduces or increases the capacities of the critical tunnels and thus the probabilities of blocking with the aid of the capacities in the FRP, such that the planned values for the probabilities of blocking are reached again.

2.1 SCR requires the TI-based method for triggering. In the RT-based method the capacity in the FRP would be used up at the time of the first check in order to reduce the current probabilities of blocking, even if they had not as yet changed compared to the planned values. The consequence would be that the FRP would be emptied prematurely, with the capacity not necessarily being used for tunnels that exceed their planned values.

2.2. If probabilities of blocking lie outside the TI and can no longer be reduced by the BA algorithm, because there is not enough capacity available in the FRP, CCR is again performed with capacities being reserved for the FRP, which also results in new planned values for the probabilities of blocking.

1.-7. (canceled)

8. A method for adjusting capacitor tunnels in a network having a plurality of nodes in which tunnels for data transmission capacity can be set up on the links between the nodes, comprising:
determining a communication matrix in the network;
assigning a respective capacitor tunnel in accordance with the communication matrix for a link;
determining an updated communication matrix in the network in accordance with a trigger event; and
adapting a size of the capacitor tunnel to the updated communication matrix.

9. The method as claimed in claim 8, wherein the trigger event is specified by expiry of a predefined time interval.

10. The method as claimed in claim 8, wherein the trigger event is specified by exceeding an upper traffic threshold of the link, as determined by the updated communication matrix.

11. The method as claimed in claim 10, wherein the trigger event is specified by undershooting a lower traffic threshold of the link, as determined by the updated communication matrix.

12. The method as claimed in claim 8, wherein all capacity tunnels of all links are adapted to the updated communication matrix.

13. The method as claimed in claim 8,
wherein a stock of data transmission capacity common to a plurality of tunnels is provided, and
wherein a capacitor tunnel takes data transmission capacity from the stock if an upper traffic threshold is exceeded or returns it to the stock if a lower traffic threshold is undershot.

14. The method as claimed in claim 8, wherein the method is performed only if a significant reduction of the current probability of blocking in the case of at least one capacitor tunnel is achieved.
